(19) United States
(12) Patent Application Publication
(10) Pub. No.: US 2026/0056832 A1
(43) Pub. Date: Feb. 26, 2026

(54) METHOD AND APPARATUS FOR PROCESSING CHECKSUMS FOR AN IN-MEMORY COMPUTING DEVICE

(71) Applicant: Robert Bosch GmbH, Stuttgart (DE)

(72) Inventors: Stefan Metzlaff, Renningen (DE); Tobias Kirchner, Ludwigsburg (DE)

(21) Appl. No.: 19/302,154

(22) Filed: Aug. 18, 2025

(30) Foreign Application Priority Data
Aug. 22, 2024 (DE) 10 2024 208 017.9

(51) Int. Cl. G06F 11/10; G06F 11/16

(52) U.S. Cl. CPC G06F 11/1004; G06F 11/1666

(57) ABSTRACT

A computer-implemented method for processing checksums for an in-memory computing device for carrying out vector-matrix multiplications. The method includes: determining at least one checksum of the in-memory computing device; checking the at least one checksum by means of a checking device.

### FIELD

The present invention relates to a method for processing checksums for an in-memory computing device.

The present invention further relates to an apparatus for processing checksums for an in-memory computing device

### SUMMARY

Some examples of the present invention relate to a method, for example a computer-implemented method, for processing checksums for an in-memory computing device, for example for performing vector-matrix multiplications, comprising: determining at least one checksum of the in-memory computing device, checking the at least one checksum by means of a checking device. In some examples, this makes it possible to detect possible errors in the in-memory computing device.

In some examples of the present invention, the in-memory computing device can also be referred to as a “dot product engine”.

In some examples of the present invention, the in-memory computing device can be used, for example, for applications in the field of artificial intelligence, such as machine learning, for example for performing computational operations such as those used in training and/or inference by means of neural networks.

In some examples of the present invention, the in-memory computing device may be implemented at least partially as a digital device or at least partially as an analog device.

In some examples of the present invention, the checking device is arranged in a target system identical to the in-memory computing device, for example on an identical carrier, for example substrate, for semiconductor components. This results in a particularly small configuration, while at the same time making it possible to check the in-memory computing device.

For example, the checking device has a processor device, for example a central processor unit, for example a CPU, which can be brought into data connection with the in-memory computing device at least temporarily by means of a data connection device, for example having a data bus or an on-chip network, wherein the method comprises: reading, by means of the processor device, the at least one checksum of the in-memory computing device; comparing, by means of the processor device, the at least one checksum of the in-memory computing device with a reference checksum, for example stored beforehand in a memory device for the processor device; optionally executing, by means of the processor device, a measure based on the comparison.

For example, the at least one checksum can be stored at least temporarily in a memory area of the in-memory computing device, e.g. as a result of an (in-memory) calculation based on prespecifiable input data, e.g., at least one test sample.

In some examples of the present invention, the checking device is designed as, for example, a dedicated hardware device, for example as a comparator device (e.g. comparator), wherein the checking device is arranged in the area of the in-memory computing device, for example is integrated into the in-memory computing device, wherein the method comprises at least one of the following elements: a) providing at least one reference checksum, e.g. in a register storage device, or b) carrying out a comparison, e.g. byte-by-byte, of the at least one checksum of the in-memory computing device with one or more of the at least one reference checksums, by means of the comparator device, or c) buffering, by means of the comparator device, a plurality of checksums, or d) comparing, e.g., simultaneously comparing, a plurality of checksums with a relevant reference checksum.

In some examples of the present invention, it may be provided to provide, for example, transmit, several checksums, e.g. per column of a memory device of the in-memory computing device, e.g. in the form of a matrix (having rows and columns), and then to successively apply different input vectors as input data to the in-memory computing device and compare them with the checksum assigned to the relevant input vector.

In some examples of the present invention, the in-memory computing device may form or represent a functional block, for example for a semiconductor device, for example a chip. For example, the functional block can be characterized by a so-called macro, e.g. an in-memory computing, IMC, macro. In some examples, the checking device can be integrated directly into the (IMC) macro of the in-memory computing device, which can result in particularly efficient production.

Some examples of the present invention relate to a method according to the disclosure, wherein the checking device is designed as a further in-memory computing device, wherein the method comprises: at least temporarily storing at least one of the following elements: a) an inverted, for example bit-wise inverted, reference checksum in the further in-memory computing device, for example as weightings for processing input data for the further in-memory computing device, or b) a reference checksum in the further in-memory computing device, for example as weightings for processing input data for the further in-memory computing device.

The reference checksum characterizes, for example, the information, such as data or one or more values, which can be determined in the form of the checksum when the in-memory computing device is functioning properly. In other words, if the checksum matches the reference checksum, it can be concluded that the in-memory computing device is working correctly. However, if the checksum does not match the reference checksum, it can be concluded, for example, that the in-memory computing device is not working correctly.

In some examples of the present invention, the method comprises: supplying the at least one checksum to the in-memory computing device as input data for the further in-memory computing device; executing, by means of the further in-memory computing device, a first bitwise AND function with respect to the input data and to the reference checksum, present, for example bitwise inverted, as weightings for processing the input data. This allows the checksum of the in-memory computing device, for example, to be efficiently checked by the other in-memory computing device.

For example, the method comprises: supplying a bitwise inverted form of the at least one checksum to the in-memory computing device as input data for the further in-memory computing device; executing, by means of the further in-memory computing device, a bitwise AND function with respect to the input data and the reference checksum present as weightings for processing the input data. This provides another opportunity for verification.

In some examples of the present invention, the method comprises: evaluating at least one of the following elements: a) result of executing the first bitwise AND function, or b) result of executing the second bitwise AND function, wherein, for example, the evaluating comprises at least one of the following elements: a) checking whether both results in each case have a prespecifiable (e.g. arbitrary) value, for example, are zero, or b) adding the results and checking whether the sum of the results is zero.

In some examples of the present invention, the method comprises:

supplying the at least one checksum to the in-memory computing device as input data for the further in-memory computing device; executing, by means of the further in-memory computing device, a bitwise AND function with respect to the input data and the reference checksum present as weightings for processing the input data; evaluating a result of the execution of the bitwise AND function, for example with respect to the at least one checksum, for example by comparing the result with the at least one checksum, for example by means of a comparator device.

For example, the method comprises: simulating the checking device, for example the further in-memory computing device, by means of the in-memory computing device; at least temporarily using a first memory area, for example a first memory bank, of the in-memory computing device, for example for determining the at least one checksum of the in-memory computing device; at least temporarily using a second memory area, for example a second memory bank, of the in-memory computing device, for example for checking the at least one checksum. In some examples, this may avoid the need for a separate checking device since the in-memory computing device can at least temporarily perform this function.

In some examples of the present invention, the method comprises: determining a plurality of checksums, for example for different memory areas of the in-memory computing device; combining the plurality of checksums to form a combined checksum; checking the combined checksum, for example by comparing the combined checksum with a combined reference checksum. In some examples, a single comparison of the combined checksum with a combined reference checksum may be sufficient for checking a plurality of checksums.

In some examples of the present invention, combining the multiple checksums comprises, for example, combining by means of a conventional checksum method, for example of the CRC type.

In some examples of the present invention, combining the multiple checksums involves concatenating the multiple checksums.

Some examples relate to an apparatus for an in-memory computing device, for example for performing vector-matrix multiplications, wherein the apparatus is designed, for example configured, to carry out at least some aspects of the disclosure.

Some examples relate to a system comprising an in-memory computing device, for example for performing vector-matrix multiplications, and an apparatus according to the disclosure.

Some examples of the present invention relate to a computer-readable storage medium comprising commands that, when executed by a computer, cause said computer to perform the method according to the disclosure.

Some examples of the present invention relate to a computer program comprising commands that, when the program is executed by a computer, cause said computer to perform the method according to the disclosure. Some examples of the present invention relate to a data carrier signal that transmits and/or characterizes the computer program according to the disclosure.

Some examples of the present invention relate to a use of the method according to the disclosure and/or of the apparatus according to the disclosure and/or of the system according to the disclosure and/or of the computer-readable storage medium according to the disclosure and/or of the computer program according to the disclosure and/or of the data carrier signal according to the disclosure for at least one of the following elements: a) checking the at least one checksum, or b) checking a function of the in-memory computing device, or c) increasing reliability and/or security, or d) detecting errors, or e) verifying a memory content of the in-memory computing device, for example, without reading the memory content.

Further features, possible applications and advantages of the present invention will be apparent from the following description of examples shown in the figures. All features described or shown form the subject matter of the disclosure individually or in any combination, regardless of their wording or representation in the description or in the figures.

### BRIEF DESCRIPTION OF THE DRAWINGS

FIG. 1 shows schematically is a simplified flow chart, according to an example embodiment of the present invention.

FIG. 2 shows schematically is a block diagram, according to an example embodiment of the present invention.

FIG. 3 shows schematically is a block diagram, according to an example embodiment of the present invention.

FIG. 4 shows schematically is a flow chart, according to an example embodiment of the present invention.

FIG. 5 shows schematically is a simplified block diagram, according to an example embodiment of the present invention.

FIG. 6 shows schematically is a flow chart, according to an example embodiment of the present invention.

FIG. 7 shows schematically is a flow chart, according to an example embodiment of the present invention.

FIG. 8 shows schematically is a block diagram, according to an example embodiment of the present invention.

FIG. 9 shows schematically is a flow chart, according to an example embodiment of the present invention.

FIG. 10 shows schematically is a block diagram, according to an example embodiment of the present invention.

FIG. 11 shows schematically is a flow chart, according to an example embodiment of the present invention.

FIG. 12 shows schematically is a flow chart, according to an example embodiment of the present invention.

FIG. 13 shows schematically is a block diagram, according to an example embodiment of the present invention.

FIG. 14 shows schematically is aspects of uses, according to an example embodiment of the present invention.

FIG. 15 shows schematically is aspects of an in-memory computing device, according to an example embodiment of the present invention.

FIG. 16 shows schematically is aspects of an in-memory computing device, according to an example embodiment of the present invention.

FIG. 17 shows schematically is aspects of an in-memory computing device, according to an example embodiment of the present invention.

FIG. 18A shows schematically is aspects of an in-memory computing device, according to an example embodiment of the present invention.

FIG. 18B shows schematically is aspects of an in-memory computing device, according to an example embodiment of the present invention.

### DETAILED DESCRIPTION OF EXAMPLE EMBODIMENTS

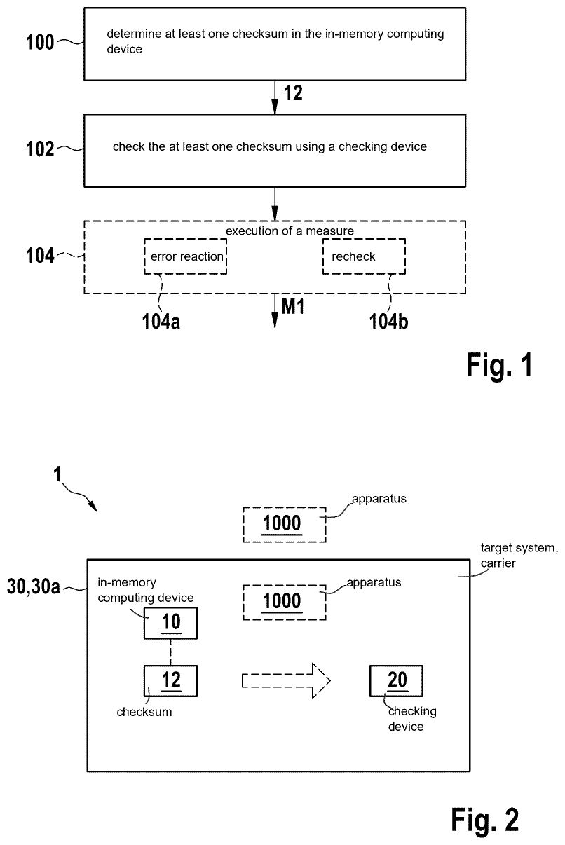

Some examples, see e.g., FIGS. 1, 2, relate to a method, for example a computer-implemented method, for processing checksums for an in-memory computing device 10 (FIG. 2), for example for carrying out vector-matrix multiplications, comprising: determining 100 (FIG. 1) at least one checksum 12 of the in-memory computing device 10; checking 102 the at least one checksum 12 by means of a checking device 20 (FIG. 2). In some examples, this makes it possible to detect possible errors in the in-memory computing device 10.

The optional block 104 according to FIG. 1 symbolizes an optional execution of a measure M1, for example based on the checking 102. For example, element 104 may comprise an error reaction 104a and/or a recheck 104b, for example repeating at least aspect 102 (optionally also aspect 100, for example in the sense of a re-determination, e.g. calculation, of the checksum 12).

In some examples, FIG. 2, the in-memory computing device 10 can also be referred to as a “dot product engine”, e.g. because it is designed to calculate the scalar product of vectors or components of matrices.

In some examples, however, the in-memory computing device 10 may, without restricting generality, alternatively or additionally also be configured to carry out other computing operations, wherein in some examples the principle according to the disclosure is applicable or transferable in a corresponding manner to configurations configured in such a manner.

In some examples, FIG. 2, the in-memory computing device 10 can be used, for example, for applications in the field of artificial intelligence, for example machine learning, for example for carrying out computing operations such as can be used, for example, in training and/or inference by means of neural networks.

In some examples, FIG. 2, the in-memory computing device 10 may be implemented at least partially as a digital device or at least partially as an analog device.

In some examples, FIG. 2, the checking device 20 is arranged in a target system 30 identical to the in-memory computing device 10, for example on an identical carrier 30a, for example a substrate, for example for semiconductor components. This results in a particularly compact configuration, with the simultaneous possibility of checking the in-memory computing device 10. Optionally, an apparatus 1000 may be provided that is configured to carry out at least some aspects of the disclosure. For example, the apparatus 1000 may also be arranged within the target system 30, for example on the substrate 30a. In further examples, the apparatus 1000 can, for example, also be arranged outside the target system 30 and, for example, be at least temporarily in data communication with at least one of the components 10, 20.

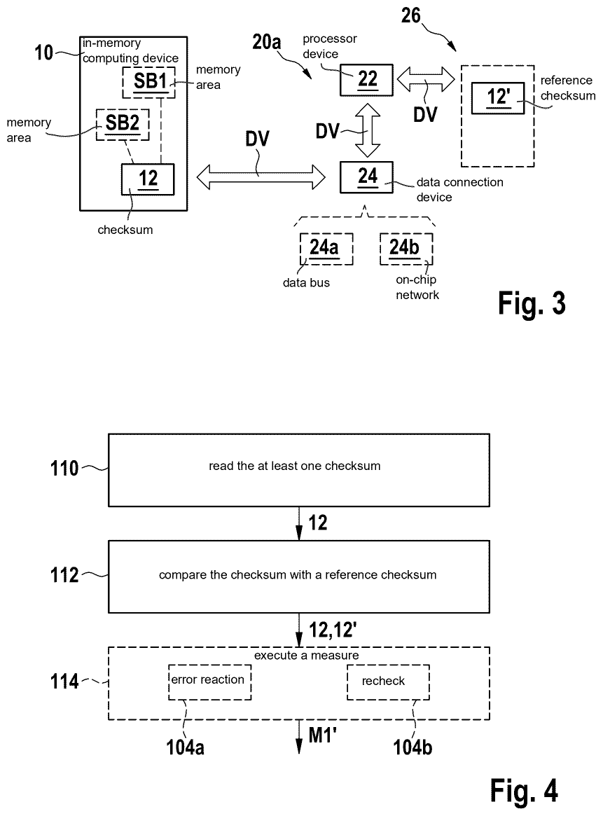

For example, FIG. 3, the checking device 20a has a processor device 22, for example a central processor unit, for example a CPU, which can be brought into data connection DV with the in-memory computing device 10 at least temporarily by means of a data connection device 24, for example having a data bus 24a or an on-chip network 24b, wherein the method, see e.g. FIG. 4, comprises: reading 110, by means of the processor device 22, the at least one checksum 12 of the in-memory computing device; comparing 112, by means of the processor device 22, the at least one checksum 12 of the in-memory computing device 10 with a reference checksum 12′, for example stored in advance (for example at a compile time) in a memory device 26 (FIG. 3) for the processor device 22; optionally executing 114, by means of the processor device 22, a measure M1′ based on comparison 112.

In some examples, FIG. 4, the optional execution 114 of the measure M1′ may in turn comprise at least one of the elements 104a, 104b; see FIG. 1 and the above description thereof.

For example, FIG. 3, the at least one checksum 12 can be stored at least temporarily in a memory area SB1, SB2, . . . of the in-memory computing device 10, e.g. as a result of an (in-memory) calculation based on prespecifiable input data, e.g. at least one prespecifiable test sample.

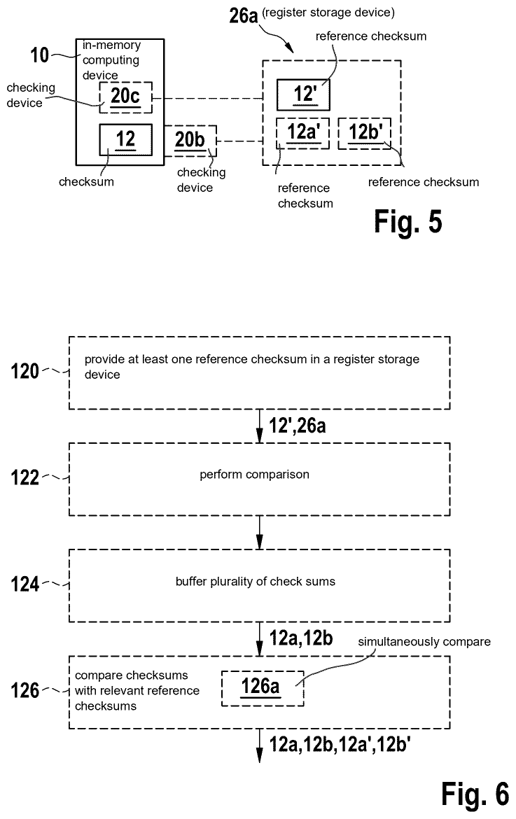

In some examples, FIG. 5, the checking device 20b, 20c is designed as a for example dedicated, hardware device, for example as a comparator device (e.g. comparator), wherein the checking device 20b, 20c is arranged in the area of the in-memory computing device 10, for example, is integrated into the in-memory computing device 10 (see variant 20b of the checking device), wherein the method comprises at least one of the following elements; see, for example, FIG. 6: a) providing 120 at least one reference checksum 12′, e.g. in a register storage device 26a (FIG. 5), or b) performing 122 a, for example, byte-wise, comparison of the at least one checksum 12 (FIG. 5) of the in-memory computing device 10 with one or more of the at least one reference checksums 12′, by means of the comparator device 20b, 20c, or c) buffering 124, by means of the comparator device 20b, 20c, a plurality of checksums 12a, 12b, or d) comparing 126, for example simultaneously comparing 126a, a plurality of checksums 12a, 12b with a relevant reference checksum 12a′, 12b′, wherein, for example, the respective reference checksums 12a′, 12b′ can also be stored in the register storage device 26a.

In some examples, FIG. 5, the in-memory computing device 10 may form or represent a functional block, for example for a semiconductor device, for example a chip. For example, the functional block can be characterized by a so-called macro, e.g. an in-memory computing (IMC) macro. In some examples, FIG. 5, the checking device 20b, 20c can be integrated, for example, directly into the (IMC) macro of the in-memory computing device 10, which can result in particularly efficient production.

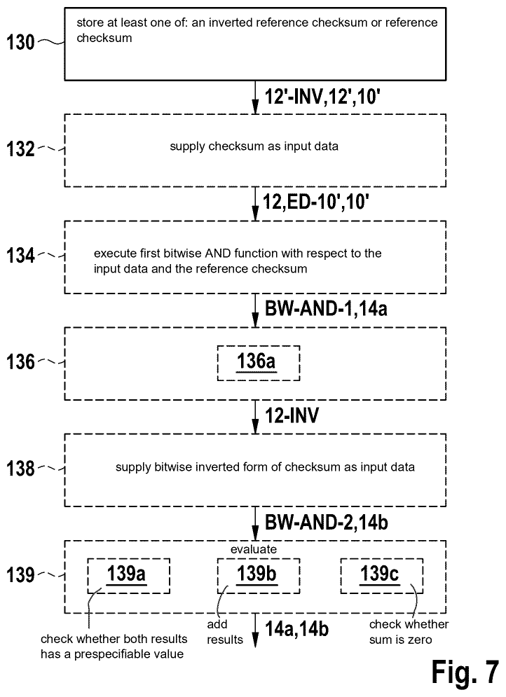

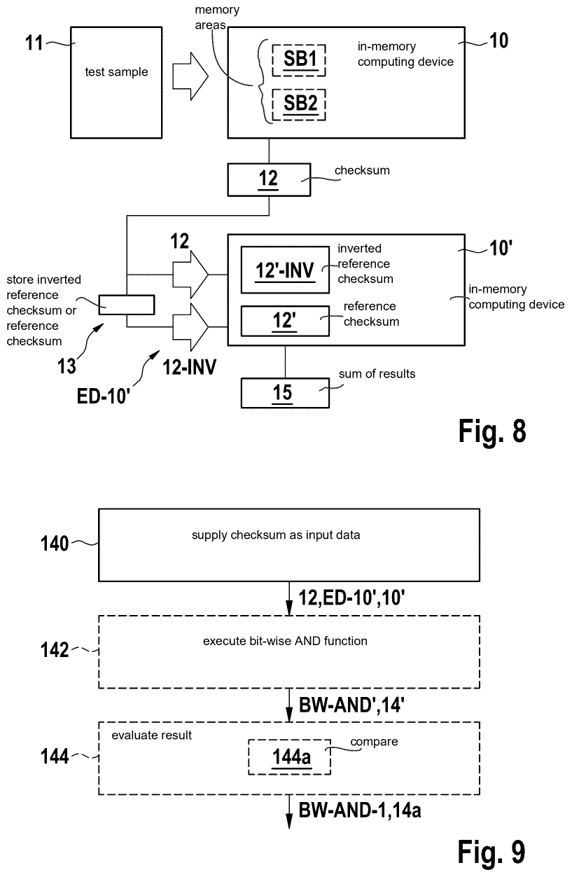

Some examples, see e.g. FIGS. 7, 8, relate to a method according to the disclosure, wherein the checking device 20 (FIG. 1) is designed as a further in-memory computing device 10′ (FIG. 8), wherein the method, see FIG. 7, comprises: at least temporarily storing 130 at least one of the following elements: a) an inverted, for example bitwise inverted, reference checksum 12′-INV in the further in-memory computing device 10′ (FIG. 8), for example as weightings for processing input data ED-10′ for the further in-memory computing device 10′, or b) a reference checksum 12′ in the further in-memory computing device 10′, for example as weightings for processing input data ED-10′ for the further in-memory computing device 10′.

The reference checksum 12′ characterizes, for example, that information, for example data or one or more values, which can be determined in the form of the checksum 12 when the in-memory computing device 10 (FIG. 8) is functioning properly. In other words, if the checksum 12 matches the reference checksum 12′, it can be concluded that the in-memory computing device 10 is working correctly. However, if the checksum 12 does not match the reference checksum 12′, it can be concluded, for example, that the in-memory computing device 10 is not working correctly.

In some examples, FIG. 7, the method comprises: supplying 132 the at least one checksum 12 of the in-memory computing device 10 as input data ED-10′ for the further in-memory computing device 10′; executing 134, by means of the further in-memory computing device 10′, a first bitwise AND function BW-AND-1 with respect to the input data and the reference checksum 12′-INV, for example bitwise inverted, present as weightings for processing the input data. As a result, the checksum 12 of the in-memory computing device 10 can be efficiently checked, for example, by the further in-memory computing device 10′.

For example, the method, see FIG. 7, comprises: supplying 136 a bitwise inverted form 12-INV of the at least one checksum 12 of the in-memory computing device 10 as input data ED-10′ for the further in-memory computing device 10′; executing 138, by means of the further in-memory computing device 10′, a bitwise AND function BW-AND-2 with respect to the input data 12-INV and the reference checksum 12′ present as weightings for processing the input data. This provides a further possibility for checking, for example as an alternative or in addition to aspects 132 and 134. The supply 136 may, for example, comprise an inversion 136a by means of an inverter device 13 (FIG. 8) in order to obtain the inverted form 12-INV.

In some examples, FIGS. 7, 8, the bitwise inverted checksum 12-INV can be derived from the checksum 12, for example by means of an optional inverter device 13.

In some examples, see e.g. FIG. 7, the method comprises: evaluating 139 at least one of the following elements: a) result 14a of executing 134 the first bitwise AND function BW-AND-1, or b) result 14b of executing 138 the second bitwise AND function BW-AND-2, wherein, for example, the evaluating 139 comprises at least one of the following elements: a) checking 139a whether both results 14a, 14b each have a prespecifiable value, for example are zero, or b) adding 139b the results 14a, 14b, and checking 139c whether the sum 15 of the results 14a, 14b is zero. The optional block 15 according to FIG. 8 thus symbolizes at least one of the following elements: a) an optional adder for forming 139b the sum, or b) the sum itself.

The configuration according to FIG. 8 has the advantage over the configuration according to FIG. 5, for example, that the in-memory computing device 10 or a possibly already existing macro associated with the in-memory computing device 10, e.g. an IMC macro, does not have to be changed for the configuration according to FIG. 8, since the further in-memory computing device 10′ is provided, which can thereby also increase the number of identical parts.

In some examples, FIG. 8, the further in-memory computing device 10′ is arranged in the region of the in-memory computing device 10, for example directly adjacent to it.

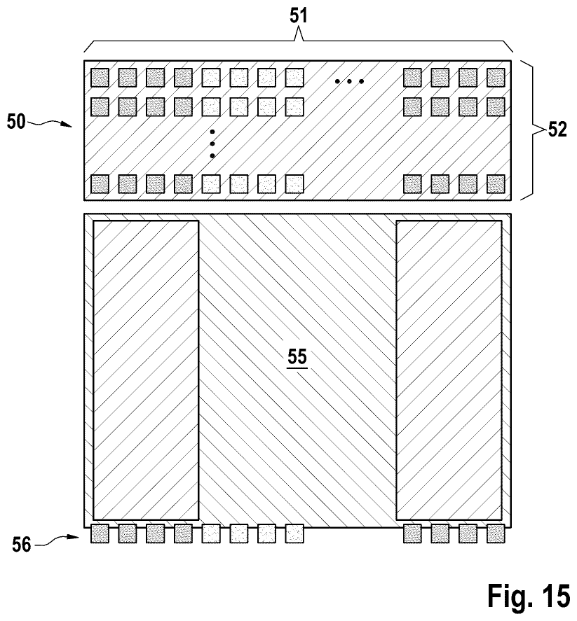

In some examples, FIG. 8, the configuration of the two in-memory computing devices 10, 10′ makes possible, for example, simultaneous processing of several checksums, for example in relation to adjacent columns or to a column of the in-memory computing device 10 and different rows of the in-memory computing device 10. Details of the arrangement of rows and columns with respect to the in-memory computing device 10 are given below with reference, for example, to FIG. 15ff.

In some examples, it is possible to create one or more checksums in situ, e.g. directly in the in-memory computing device, whereby this is secured, e.g. the input data are delivered with another, e.g. further, “checksum of the input data”, from which a checksum that can be used to calculate a scalar product is then created. In some examples, after the checksum used to calculate the dot product has been created, the input data are checked for integrity.

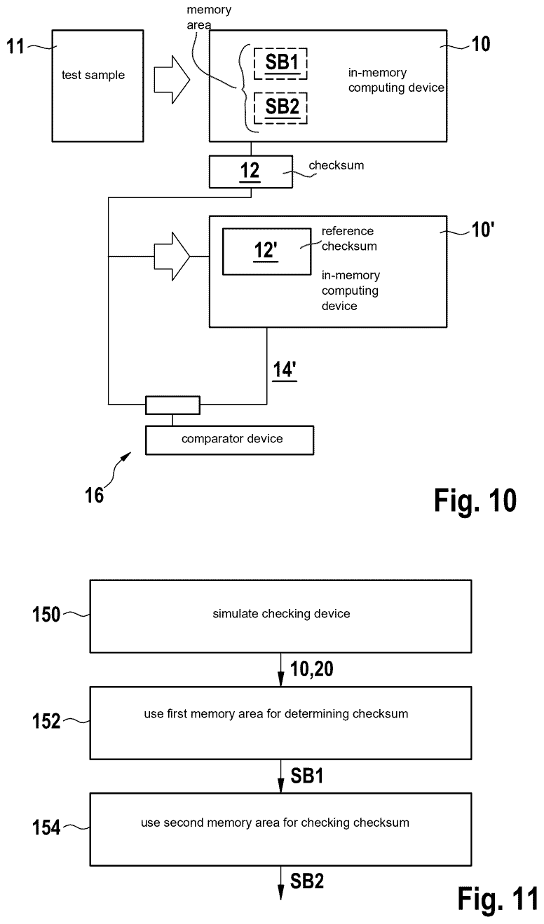

In some examples, see e.g. FIGS. 9, 10, the method comprises: supplying 140 the at least one checksum 12 of the in-memory computing device 10 as input data ES-10′ for the further in-memory computing device 10′ (FIG. 10); executing 142 (FIG. 9), by means of the further in-memory computing device 10′, a bitwise AND function BW-AND′ with respect to the input data ED-10′ and the reference checksum 12′ present as weightings for processing the input data; evaluating 144 a result 14′ of the execution 142 of the bitwise AND function BW-AND′, for example with respect to the at least one checksum 12, for example by comparing 144a the result 14′ with the at least one checksum 12, for example by means of a comparator device 16. The configuration according to FIG. 10 has the advantage over the configuration according to FIG. 8 that the information for the reference checksum 12′ is stored only once in the further in-memory computing device 10′, as compared to storage in non-inverted form 12′ and in inverted form 12′-INV according to FIG. 8.

For example, see FIG. 11, the method comprises: simulating 150 the checking device 20 (see also FIG. 2), for example the further in-memory computing device 10′ (see e.g. FIGS. 8, 10), by means of the in-memory computing device 10 (FIG. 2); at least temporarily using 152 a first memory area SB1 (see also FIGS. 3, 8, 10), for example a first memory bank, of the in-memory computing device 10, for example for determining 100 the at least one checksum 12 of the in-memory computing device 10; at least temporarily using 154 a second memory area SB2, for example a second memory bank, of the in-memory computing device 10, for example for checking 102 the at least one checksum 12. In some examples, the provision of a separate checking device 20 can be avoided since the in-memory computing device 10 can at least temporarily perform this function, wherein, for example, different information to be processed, such as a checksum or a reference checksum, can be stored, for example, in the different memory areas SB1, SB2.

In some examples, the different memory areas SB1, SB2 can also have different sizes, for example, or other, e.g. smaller, memory areas or memory banks can be provided for the processing of information associated with the (reference) checksum 12, 12′ than are provided for the regular processing of data by the in-memory computing device 10.

In some examples, the in-memory computing device 10 may also have one or more separate memory areas, for example extra columns and/or extra rows, for example to store one or more checksums at least temporarily. For example, these one or more separate memory areas can be used, for example only when at least one checksum 12 is to be checked, which can be carried out repeatedly, for example periodically. This also applies to the other examples described. In other words, in some examples, checking 102 may be performed repeatedly, for example periodically.

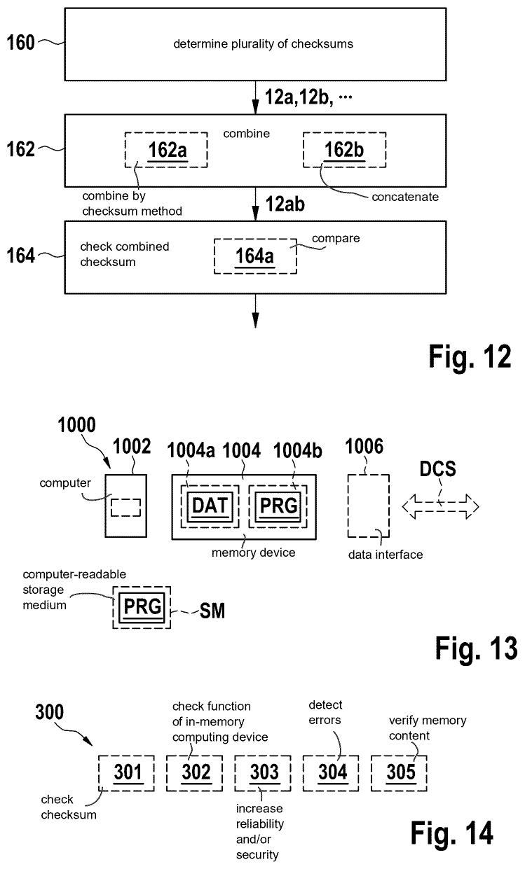

In some examples, FIG. 12, the method comprises: determining 160 a plurality of checksums 12a, 12b, . . . for example for different memory areas of the in-memory computing device 10; combining 162 the plurality of checksums 12a, 12b, . . . to form a combined checksum 12ab; checking 164 the combined checksum 12ab, for example by comparing 164a the combined checksum 12ab with a combined reference checksum. In some examples, a single comparison of the combined checksum 12ab with a combined reference checksum may thus be sufficient for checking a plurality of checksums 12a, 12b, . . .

In some examples, FIG. 12, the combining 162 of the plurality of checksums 12a, 12b, . . . comprises, for example, a combining 162a by means of a conventional checksum method, for example of the CRC type.

In some examples, FIG. 12, the combining 162 of the plurality of checksums 12a, 12b, . . . comprises, for example, a concatenation 162b of the plurality of checksums 12a, 12b, . . .

Some examples, FIG. 13, relate to an apparatus 1000 for an in-memory computing device 10, for example for performing vector-matrix multiplications, wherein the apparatus 1000 is designed, for example configured, to carry out at least some aspects of the disclosure.

In some examples, FIG. 13, the apparatus 1000 comprises: a computing device (“computer”) 1002 comprising at least one computing core 302a, a memory device 1004, assigned to the computing device 1002, for at least temporarily storing at least one of the following elements: a) data DAT, b) computer program PRG, for example for performing the method according to the examples.

For example, the data DAT are associated with at least one of the following elements: a) checksum 12, or b) formation of the checksum 12, or c) reference checksum 12′, or d) comparison of (reference) checksums 12, 12′, or e) result 14a, 14b, 14c, or f) schedule for checking the checksum 12, or g) at least one test sample 11 (FIG. 8), on the basis of which the in-memory computing device 10 forms the checksum 12, for example.

In further examples, FIG. 13, the memory device 1004 has a volatile memory (e.g. random access memory (RAM) ) 1004a, and/or a non-volatile (NVM) memory (e.g. flash EEPROM) 1004b, or a combination of these or with other types of memory not explicitly mentioned.

Further examples, FIG. 13, relate to a computer-readable storage medium SM comprising commands PRG that, when executed by a computer 1002, cause said computer to carry out the method according to the disclosure.

Further examples, FIG. 13, relate to a computer program PRG comprising commands that, when the program PRG is executed by a computer 1002, cause said computer to carry out the method according to the disclosure.

Further examples, FIG. 13, relate to a data carrier signal DCS that characterizes and/or transmits the computer program PRG according to the disclosure. The data carrier signal DCS can be received, for example, via an optional data interface 1006 of the apparatus 1000.

In some examples, FIG. 13, the functionality of the apparatus 1000 can be realized by means of a, for example pure, hardware circuit, wherein the apparatus 1000 is, for example, integrable or integrated into an IMC macro, e.g. of the in-memory computing device 10.

In some examples, FIG. 13, the functionality of the apparatus 1000 may also be used to implement at least some aspects of the processor device 22 (FIG. 3).

Some examples, FIG. 2, relate to a system 1 comprising an in-memory computing device 10, for example for performing vector-matrix multiplications, and an apparatus 1000 according to the disclosure.

Some examples, FIG. 14, relate to a use 300 of the method according to the disclosure and/or of the apparatus 1000 according to the disclosure and/or of the system 1 according to the disclosure and/or of the computer-readable storage medium SM according to the disclosure and/or of the computer program PRG according to the disclosure and/or of the data carrier signal DCS according to the disclosure for at least one of the following elements: a) checking 301 the at least one checksum 12, or b) checking 302 a function of the in-memory computing device 10, or c) increasing 303 a reliability and/or security, or d) detecting 304 errors, or e) verifying 305 a memory content of the in-memory computing device 10, for example, without reading the memory content.

Further aspects and examples are described below, which, in further examples, can each be combined individually or in any combination with one another with at least one of the aspects and/or examples described above.

FIG. 15 shows schematically by way of example a digital version of an in-memory computing device designed, for example, as a “dot product engine”, DPE. For example, the in-memory computing device 10 may have a comparable or at least similar structure.

For example, the DPE according to FIG. 15 has a plurality 50 of memory cells, organized for example in matrix form, i.e. having a plurality of columns 51 and rows 52, wherein for example the plurality of columns 51 are associated with e.g. 64×4 many bit lines and the plurality of rows 52 are associated with e.g. 64 word lines.

The element 55 according to FIG. 15 symbolizes a plurality of, in the present case for example, 64, adders, and, optionally, shift registers, and element 56 symbolizes an output of the DPE at which the calculation results of the in-memory calculations can be output. For example, the checksum 12 can also be provided at the output 56, as a calculation result, e.g. on the basis of a prespecifiable test sample 11 (FIG. 8) as input data.

For example, each cell of a column of the DPE according to FIG. 15 has a direct connection (not shown) to a relevant adder. In order to apply an input vector that can be formed from the input data, in some examples, for example, several lines can be activated simultaneously.

In some examples, a key difference between DPE and normal block memory, as used for other computing purposes, may be that normal block memory can, for example, only activate one row (“word line”) and read its contents. However, in some examples, the present DPE can activate multiple rows and automatically add the contents of a column.

In some examples, a column of the exemplary digital version of the DPE may comprise a single bit or multiple bits, e.g. four adjacent bits, which are interpreted e.g. as a single value, e.g. a nibble or a byte. FIG. 15 symbolically shows, by way of example, four horizontally adjacent bits which form, for example, a four-bit number which is added, for example, by an adder. In other words, the DPE according to FIG. 15 can be understood in some examples as an array of memory cells with adders, which are each assigned, for example, to groups of columns of the array.

In some examples, the DPE may have conventional access structures (not shown) that make it possible, for example, to read and/or write contents of the DPE memory cells. In some examples, these access structures may differ slightly from conventional memories, e.g. when reading the contents, the values may be passed through the adder or bypassed.

The principle according to the disclosure can be applied, for example, to in-memory computing devices 10, e.g. at least in a similar way to the DPE according to FIG. 15, for example to check the in-memory computing devices 10 for proper functioning, for example in the sense of functional safety (e.g. “safety”), for example when the in-memory computing devices 10 are used for safety-critical target systems such as, for example, automated driving (e.g. evaluation of video data of an environment of a moving vehicle using artificial intelligence algorithms, wherein the inference is carried out, for example, by at least one in-memory computing device 10).

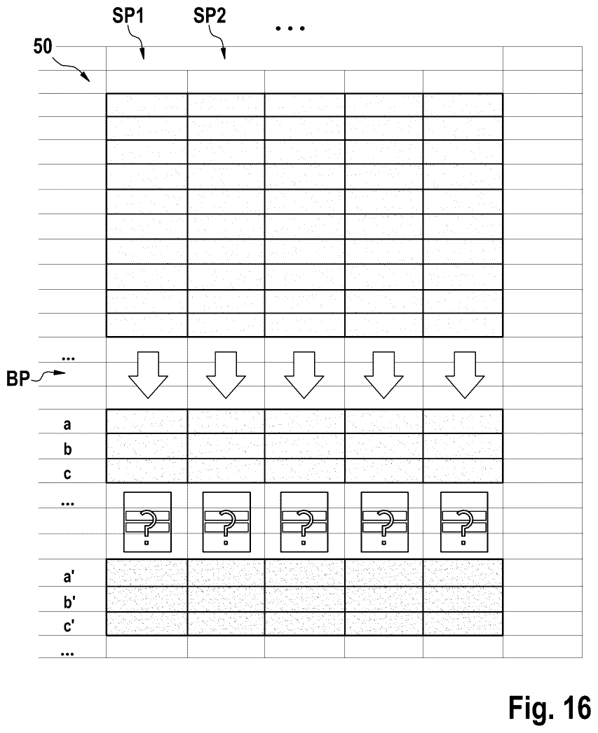

FIG. 16 shows an example of the memory cells 50, wherein, for example, a checksum 12 is formed for each column SP1, SP2, see, for example, the block arrows collectively designated by the reference symbol BP.

In some examples, several checksums can, for example, be formed for at least some, for example all, columns SP1, SP2, . . . for example based on several different test samples 11; see lines a, b, c according to FIG. 16. In further examples, FIG. 16, the plurality of checksums may be compared with corresponding respective reference checksums; see lines a′, b′, c′, for example using the principle according to the disclosure.

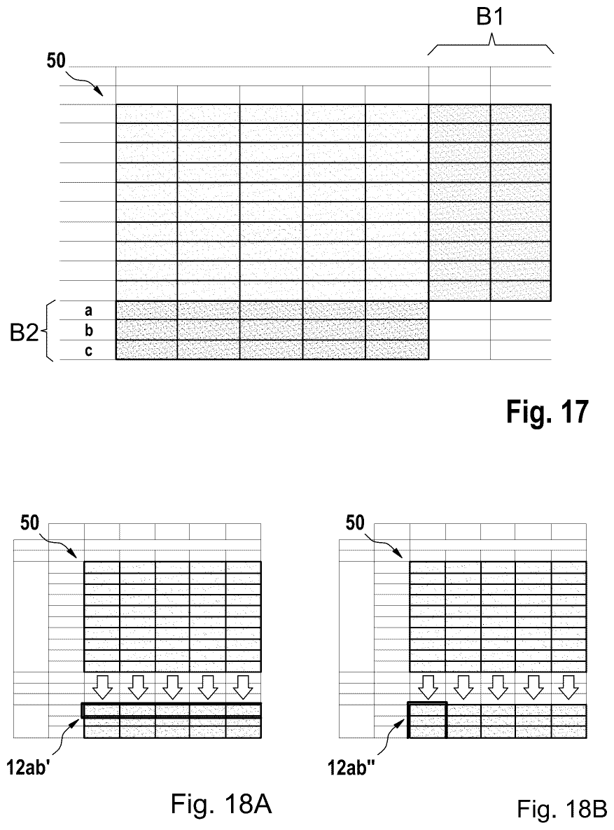

FIG. 17 illustrates possible arrangements of one or more reference checksums in relation to the memory cells 50 according to some examples, wherein the bracket B1 denotes columns for at least temporarily storing at least one reference checksum and wherein the bracket B2 denotes rows for the at least temporary storage of at least one reference checksum.

In some examples, FIG. 17, it is also possible to store the checksums in the column itself, e.g. at the end of a relevant column. For this purpose, a holding register for the checksums can be provided, which is also connected to an adder tree, e.g. at the end of the IMC macro. In some examples, the checksum holding register is large enough to hold a number that, when added, would cause the adder to overflow. In some examples, such an overflow means that the sum is zero, which can easily be checked by using an OR gate, for example. The number that can be stored in the holding register for the checksum is then, for example, (AdderFullscale−ExpectedTestPatternResult+1).

For example, the expected check result, if correct, together with the checksum in the last (or any other) line would in some examples add up to exactly zero. Example: Adder 8 bit, so the largest value that can be in the output register of the adder is 0xff (hexadecimal), i.e. 255 (decimal) . If the expected result of a column operation is, for example, the value 200, the value 55+1 must be entered in the last row. This last line then causes the adder to overflow to zero. But only if the calculation result without the checksum is exactly 200.

In some examples, the last line can also be called a “checksum line”. As an alternative to being placed in the last line, in some examples the checksum can also be placed somewhere else, e.g. in the first position, e.g. in a first line, e.g. stored at least temporarily.

In some examples, it is therefore intended that the checksum line is also activated, whereas the other lines are activated, for example, according to the input vector.

In some examples, one could alternatively test for “0xff” using the principle according to the disclosure, this requiring a comparably low effort as testing for “zero”. In other words, the additional number would not be zero, but 0xff. In some examples, this could be achieved by provoking an overflow above zero. The correction value from the above example would then be 5. In further examples, all other numbers apart from 0 and 0xff are possible, for example 0x04, or any other number in the corresponding value range.

In some examples, for example, instead of an overflow, the adder of the DPE can also be expanded with the ability to subtract. In this case, for example, the checksum holding register holds a reference checksum and subtracts it, e.g. to achieve the comparatively easily testable zero value. This would be analogous to what was described above. In the example, the checksum would be −200 or +200 with the instruction to the adder to subtract this number. Then the result is zero again.

Likewise, in some examples, one could test for 0xff, which would be just as easy as testing for zero. The additional number would then not be zero, for example, but 0xff. This could be achieved, for example, by provoking an overflow above zero. A correction value from the above example would then be −201.

Alternatively, in some examples, the adder can be preloaded with a value that, when added to the expected test result, results in zero or some other easily verifiable condition, e.g. that the MSB (most significant bit) has been set. This can be intended, for example, if the specified value from somewhere else is received instead of an additional line. In some examples, this preloaded value plus the regular column result, e.g. from scalar multiplication, results in a value that can be tested after the calculation. In some examples, it is preferable to always test for the same value, e.g. because this can then be done in hardware. In some examples, the preloaded value complements the calculated value, so to speak, so that the two together result in a value that can be verified using hardware.

As an alternative to an overflow, in some examples the adder may be so large that adding the checksum activates the MSB (or at least another bit), so that, for example, the MSB is tested for “1” and all lower bits for “0”.

FIG. 18A illustrates possible combinations of a plurality of checksums in relation to the memory cells 50 according to some examples, wherein in the present case a plurality of checksums arranged in a same row are combined to form a combined checksum 12ab′, e.g. by means of CRC methods or concatenation.

FIG. 18A illustrates possible combinations of multiple checksums in relation to the memory cells 50 according to some examples, wherein in the present case multiple checksums arranged in a same column are combined to form a combined checksum 12ab″, e.g. by means of CRC methods or concatenation.

In some examples, a combining principle comparable to FIGS. 18A, 18B can also be applied, for example, to the respective reference checksums (not shown).

In some examples, the principle of combining checksums or reference checksums can also be applied hierarchically, so that, for example, a first group of combined checksums is combined again, for example with a second group of already combined checksums, and so on.

Error detection can be ensured by selecting appropriately large values or number ranges for the (combined, possibly e.g. multiply combined) checksums.

1-17. (canceled)

18. A computer-implemented method for processing checksums for an in-memory computing device for carrying out vector-matrix multiplications, the method comprising the following steps:
determining at least one checksum of the in-memory computing device; and
checking the at least one checksum using a checking device.

19. The method according to claim 18, wherein the checking device is arranged in a same target system and on a same carrier as the in-memory computing device.

20. The method according to claim 18, wherein the checking device includes a processor device which can be brought into data connection with the in-memory computing device at least temporarily using a data connection device including a data bus or an on-chip network, and wherein the method further comprises the following steps:
reading, using the processor device, the at least one checksum of the in-memory computing device;
comparing, using the processor device, the at least one checksum of the in-memory computing device with a reference checksum stored in advance in a memory device for the processor device;
executing, usng the processor device, a measure based on the comparison.

21. The method according to claim 18, wherein the checking device is a dedicated hardware device including a comparator device, wherein the checking device is integrated into the in-memory computing device, and wherein the method further comprises at least one of the following steps:
a) providing at least one reference checksum in a register storage device, or
b) carrying out a byte-wise comparison of the at least one checksum of the in-memory computing device with one or the reference checksum, or
c) buffering, using the comparator device, a plurality of checksums, or
d) simultaneously comparing several checksums with a relevant reference checksum.

22. The method according to claim 18, wherein the checking device is a further in-memory computing device, and the method further comprises:
at least temporarily storing at least one of the following elements: a) an inverted, for example bit-wise inverted, reference checksum in the further in-memory computing device as weightings for processing input data for the further in-memory computing device, or b) a reference checksum in the further in-memory computing device as weightings for processing input data for the further in-memory computing device.

23. The method according to claim 22, further comprising:
supplying the at least one checksum to the in-memory computing device as the input data for the further in-memory computing device;
executing, using the further in-memory computing device, a first bitwise AND function with respect to the input data and the reference checksum, bitwise inverted, present as weightings for processing the input data.

24. The method according to claim 22, further comprising:
supplying a bitwise inverted form of the at least one checksum to the in-memory computing device as the input data for the further in-memory computing device;
executing, using the further in-memory computing device, a bitwise AND function with regard to the input data and the reference checksum present as weightings for processing the input data.

25. The method according to claim 23, further comprising:
evaluating at least one of the following elements: a) result of the execution of a first bitwise AND function, or b) result of the execution of a second bitwise AND function,
wherein the evaluating includes at least one of the following elements: a) checking whether the result of the execution of the first bitwise AND function and the result of the execution of the second bitwise AND function, each have a prespecifiable value, or b) adding the result of the execution of the first bitwise AND function and the result of the execution of the second bitwise AND function, and checking whether a sum of the result of the execution of the first bitwise AND function and the result of the execution of the second bitwise AND function is zero.

26. The method according to claim 22, further comprising:
supplying the at least one checksum to the in-memory computing device as input data for the further in-memory computing device;
executing, using the further in-memory computing device, a bitwise AND function with respect to the input data and the reference checksum present as weightings for processing the input data; and
evaluating a result of the execution of the bitwise AND function with respect to the at least one checksum, by comparing the result of the execution with the at least one checksum, using a comparison device.

27. The method according to claim 18, further comprising:
simulating the checking device, using the in-memory computing device;
at least temporarily using a first memory area of the in-memory computing device, for determining the at least one checksum of the in-memory computing device; and
at least temporarily using a second memory area of the in-memory computing device, for checking the at least one checksum.

28. The method according to claim 18, further comprising:
determining a plurality of checksums for different memory areas of the in-memory computing device;
combining the plurality of checksums to form a combined checksum;
checking the combined checksum, by comparing the combined checksum with a combined reference checksum.

29. An apparatus for an in-memory computing device for carrying out vector-matrix multiplications, wherein the apparatus is configured to process checksums for an in-memory computing device for carrying out the vector-matrix multiplications, the apparatus being configured to:
determine at least one checksum of the in-memory computing device; and
check the at least one checksum using a checking device.

30. A system, comprising:
an in-memory computing device configured to perform vector-matrix multiplications; and
an apparatus for the in-memory computing device, wherein the apparatus is configured to process checksums for the in-memory computing device for carrying out the vector-matrix multiplications, the apparatus being configured to:
determine at least one checksum of the in-memory computing device; and
check the at least one checksum using a checking device.

31. A non-tranistory computer-readable storage medium on which is stored instructions for processing checksums for an in-memory computing device for carrying out vector-matrix multiplications, the instructions, when executed by a computer, causing the computer to perform the following steps:
determining at least one checksum of the in-memory computing device; and
checking the at least one checksum using a checking device.

32. The method according to claim 18, the method is for at least one of the following elements: a) checking the at least one checksum, or b) checking a function of the in-memory computing device, or c) increasing reliability and/or security, or d) detecting errors, or e) verifying a memory content of the in-memory computing device without reading the memory content.
